(19) United States
(12) Patent Application Publication
(10) Pub. No.: US 2023/0036223 A1
(43) Pub. Date: Feb. 2, 2023

(54) NONAQUEOUS ELECTROLYTE ENERGY STORAGE DEVICE AND ENERGY STORAGE APPARATUS, METHODS FOR USE THEREOF, AND MANUFACTURING METHODS THEREFOR

(71) Applicant: GS YUASA INTERNATIONAL LTD., Kyoto-shi, Kyoto (JP)

(72) Inventors: Shinya OTANI, Kyoto-shi, Kyoto (JP); Takenori TOYAMA, Kyoto-shi, Kyoto (JP); Daisuke ENDO, Kyoto-shi, Kyoto (JP)

(21) Appl. No.: 17/788,864

(22) PCT Filed: Dec. 16, 2020
(86) PCT No.: PCT/JP2020/046956

§ 371 Date: Jun. 24, 2022

(30) Foreign Application Priority Data
Dec. 25, 2019 (JP) 2019-233934

(51) Int. Cl. H01M 4/525; H01M 4/505; C01G 53/00

(52) U.S. Cl. CPC H01M 4/525; H01M 4/505; C01G 53/50; H01M 2004/028

(57) ABSTRACT

A nonaqueous electrolyte energy storage device according to one aspect of the present invention is a nonaqueous electrolyte energy storage device including a positive electrode having positive active material particles, in which the positive active material particles contain a lithium transition metal composite oxide having an α-NaFeO₂ structure, the lithium transition metal composite oxide contains at least one of nickel and cobalt, and manganese, a content of lithium with respect to a transition metal in the lithium transition metal composite oxide exceeds 1.0 in terms of a molar ratio, a diffraction peak is present in a range of 20° or more and 22° or less in an X-ray diffraction diagram of the lithium transition metal composite oxide using a CuKα ray, and the positive active material particles contain aluminum.

### TECHNICAL FIELD

The present invention relates to a nonaqueous electrolyte energy storage device and an energy storage apparatus, methods for their use, and their manufacturing methods.

### BACKGROUND ART

Applications of a nonaqueous electrolyte energy storage device represented by a lithium secondary battery have been increasingly expanded in recent years, and development of various positive active materials has been required. Heretofore, a lithium transition metal composite oxide having an α-NaFeO₂-type crystal structure has been examined as a positive active material for a nonaqueous electrolyte energy storage device, and a nonaqueous electrolyte secondary battery using LiCoO₂ has been widely put to practical use. A nonaqueous electrolyte secondary battery using a so-called LiMeO₂-type active material in which manganese that is abundant as an earth resource is used as a transition metal (Me) constituting a lithium transition metal composite oxide, and a molar ratio (Li/Me) of lithium to the transition metal constituting the lithium transition metal composite oxide is almost 1 has also been put to practical use.

On the other hand, in recent years, among lithium transition metal composite oxides having an α-NaFeO₂-type crystal structure, a so-called lithium-excess-type active material of which the molar ratio (Li/Me) of lithium to the transition metal is more than 1 has been developed (Patent Documents 1 and 2). A nonaqueous electrolyte energy storage device using such a lithium-excess-type active material attracts attention because the nonaqueous electrolyte energy storage device has a larger discharge capacity than the LiMeO₂-type active material.

In a conventional nonaqueous electrolyte energy storage device using a lithium-excess-type active material for a positive electrode, in order to exhibit the above effect, the nonaqueous electrolyte energy storage device is generally manufactured through initial charge-discharge until the positive electrode potential reaches 4.5 V vs. Li/Li⁺ or more. In Patent Document 1, at the time of initial charge-discharge of a nonaqueous electrolyte secondary battery using a lithium-excess-type active material for a positive electrode and using silicon and carbon for a negative electrode, charge is performed until the positive electrode potential reaches 4.60 V vs. Li/Li⁺. In Patent Document 2, at the time of initial charge-discharge of a nonaqueous electrolyte secondary battery using a lithium-excess-type active material for a positive electrode and using graphite for a negative electrode, charge is performed until the voltage reaches 4.7 V, that is, until the positive electrode potential reaches 4.8 V vs. Li/Li⁺.

### PRIOR ART DOCUMENTS

### Patent Documents

Patent Document 1: JP-A-2012-104335

Patent Document 2: JP-A-2013-191390

### SUMMARY OF THE INVENTION

### Problems to be Solved by the Invention

In the nonaqueous electrolyte energy storage device, it is desirable that internal resistance does not increase even when a charge-discharge cycle is repeated. However, a nonaqueous electrolyte energy storage device using a conventional lithium-excess-type active material for a positive electrode also has a problem that the internal resistance tends to increase with the charge-discharge cycle.

An object of the present invention is to provide a nonaqueous electrolyte energy storage device using a lithium-excess-type active material for a positive electrode, in which an increase in internal resistance associated with a charge-discharge cycle is suppressed, an energy storage apparatus, methods for using such a nonaqueous electrolyte energy storage device and an energy storage apparatus, and their manufacturing methods.

### Means for Solving the Problems

A nonaqueous electrolyte energy storage device according to one aspect of the present invention is a nonaqueous electrolyte energy storage device including a positive electrode having positive active material particles, in which the positive active material particles contain a lithium transition metal composite oxide having an α-NaFeO₂ structure, the lithium transition metal composite oxide contains at least one of nickel and cobalt, and manganese, a content of lithium with respect to a transition metal in the lithium transition metal composite oxide exceeds 1.0 in terms of a molar ratio, a diffraction peak is present in a range of 200 or more and 220 or less in an X-ray diffraction diagram of the lithium transition metal composite oxide using a CuKα ray, and the positive active material particles contain aluminum.

Another aspect of the present invention is an energy storage apparatus including two or more nonaqueous electrolyte energy storage devices, and one or more of the nonaqueous electrolyte energy storage devices according to another aspect of the present invention.

A method for using the nonaqueous electrolyte energy storage device according to another aspect of the present invention is a method for using the nonaqueous electrolyte energy storage device according to one aspect of the present invention, the method including charging at a positive electrode potential in a range of less than 4.5 V vs. Li/Li⁺.

A method for using an energy storage apparatus according to another aspect of the present invention is a method for using the energy storage apparatus according to one aspect of the present invention, the method including charging one or more of the nonaqueous electrolyte energy storage devices at a positive electrode potential in a range of less than 4.5 V vs. Li/Li⁺.

A method for manufacturing a nonaqueous electrolyte energy storage device according to another aspect of the present invention is a method for manufacturing the nonaqueous electrolyte energy storage device according to one aspect of the present invention, the method including performing initial charge-discharge at a positive electrode potential in a range of less than 4.5 V vs. Li/Li⁺.

A method for manufacturing an energy storage apparatus according to another aspect of the present invention is a method for manufacturing the energy storage apparatus according to one aspect of the present invention, the method including performing initial charge-discharge of one or more of the nonaqueous electrolyte energy storage devices at a positive electrode potential in a range of less than 4.5 V vs. Li/Li⁺.

### Advantages of the Invention

According to one aspect of the present invention, it is possible to provide a nonaqueous electrolyte energy storage device using a lithium-excess-type active material for a positive electrode, in which an increase in internal resistance associated with a charge-discharge cycle is suppressed, an energy storage apparatus, methods for using such a nonaqueous electrolyte energy storage device and an energy storage apparatus, and their manufacturing methods.

### BRIEF DESCRIPTION OF THE DRAWINGS

FIG. 1 is a transparent perspective view illustrating a nonaqueous electrolyte energy storage device according to an embodiment of the present invention.

FIG. 2 is a schematic view illustrating an energy storage apparatus configured by assembling a plurality of the nonaqueous electrolyte energy storage devices according to an embodiment of the present invention.

### MODE FOR CARRYING OUT THE INVENTION

First, outlines of a nonaqueous electrolyte energy storage device and an energy storage apparatus disclosed in the present specification, methods for their use, and their manufacturing methods will be described.

A nonaqueous electrolyte energy storage device according to one aspect of the present invention is a nonaqueous electrolyte energy storage device including a positive electrode having positive active material particles, in which the positive active material particles contain a lithium transition metal composite oxide having an α-NaFeO₂ structure, the lithium transition metal composite oxide contains at least one of nickel and cobalt, and manganese, a content of lithium with respect to a transition metal in the lithium transition metal composite oxide exceeds 1.0 in terms of a molar ratio, a diffraction peak is present in a range of 200 or more and 220 or less in an X-ray diffraction diagram of the lithium transition metal composite oxide using a CuKα ray, and the positive active material particles contain aluminum.

The nonaqueous electrolyte energy storage device according to one aspect of the present invention is a nonaqueous electrolyte energy storage device using a lithium-excess-type active material for a positive electrode, in which an increase in internal resistance associated with a charge-discharge cycle is suppressed. Although the reason why such an effect occurs is not clear, the following reason is presumed. The lithium transition metal composite oxide provided in the positive electrode of the nonaqueous electrolyte energy storage device is a lithium transition metal composite oxide having a diffraction peak at a diffraction angle 2θ in a range of 200 or more and 22° or less in an X-ray diffraction diagram. In the X-ray diffraction diagram for the synthesized lithium-excess-type active material (lithium transition metal composite oxide having an α-NaFeO₂ structure and a lithium content relative to a transition metal of more than 1.0 in terms of molar ratio) before charge-discharge, there is a diffraction peak in a range of 20° or more and 22° or less appearing in a monoclinic crystal of Li[Li_{1/3}Mn_{2/3}]02 type. In the conventional nonaqueous electrolyte energy storage device using the lithium-excess-type active material, in order to activate the lithium-excess-type active material, the initial charge-discharge is performed until the positive electrode potential reaches 4.5 V vs. Li/Li⁺ or more as described above (hereinafter, “the fact that the lithium-excess-type active material is activated by charge at which the positive electrode potential reaches 4.5 V vs. Li/Li⁺ or more” is also referred to as high potential formation). When charge is performed such that the positive electrode potential reaches 4.5 V vs. Li/Li⁺ or more, the diffraction peak in the range of 20° or more and 220 or less disappears due to a change in symmetry of crystal accompanying lithium extraction in the crystal. That is, the presence of the diffraction peak in the range of 200 or more and 220 or less means that charge (high potential formation) at which the positive electrode potential reaches 4.5 V vs. Li/Li⁺ or more is not performed. In the case of a conventional lithium-excess-type active material subjected to high potential formation, the occurrence of a change in the crystal structure in a direction in which a diffusion rate of lithium ions in a solid phase decreases is considered to be one of the factors that increase the internal resistance associated with the charge-discharge cycle. On the other hand, the lithium-excess-type active material (lithium transition metal composite oxide) provided in the nonaqueous electrolyte energy storage device is not subjected to high potential formation. For this reason, in the lithium-excess-type active material provided in the nonaqueous electrolyte energy storage device, it is considered that the change in the crystal structure in the direction in which the diffusion rate of lithium ions in the solid phase decreases is unlikely to occur, and this is presumed to be one of the factors of suppressing the increase in the internal resistance associated with the charge-discharge cycle in the nonaqueous electrolyte energy storage device.

In the case of a lithium transition metal composite oxide containing manganese, elution of manganese associated with charge-discharge cycle is considered to be one of the factors that increase the internal resistance. On the other hand, in the nonaqueous electrolyte energy storage device, it is presumed that since the positive active material particles contain aluminum, the elution of manganese is suppressed, and as a result, the increase in the internal resistance is suppressed.

As described above, according to the nonaqueous electrolyte energy storage device, it is presumed that a combination of the fact that the diffraction peak is present in the range of 200 or more and 22° or less in the X-ray diffraction diagram of the lithium transition metal composite oxide using the CuKα ray and the fact that the positive active material particles contain aluminum suppresses the increase in the internal resistance associated with the charge-discharge cycle.

The nonaqueous electrolyte energy storage device according to one aspect of the present invention can also have a high capacity retention ratio after the charge-discharge cycle. In the nonaqueous electrolyte energy storage device not subjected to high potential formation, it is presumed that the lithium-excess-type active material is gradually activated by repeating charge-discharge during use, and lithium ions extracted from the lithium-excess-type active material during charge-discharge gradually increase (hereinafter, “the fact that the lithium-excess-type active material is gradually activated associated with repeating charge-discharge during use and the like” is also referred to as temporal formation). Thus, according to the nonaqueous electrolyte energy storage device, since it is presumed that consumption of lithium ions by the negative electrode in the charge-discharge cycle is compensated by replenishment from the lithium-excess-type active material of the positive electrode, the capacity retention ratio after the charge-discharge cycle is also high.

A composition ratio of the lithium transition metal composite oxide in the present specification refers to a composition ratio when a completely discharged state is provided by the following method. First, the nonaqueous electrolyte energy storage device is subjected to constant current charge with a current of 0.05 C until the voltage becomes an end-of-charge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. After the battery is disassembled to take out the positive electrode, a test battery using a metal lithium electrode as the counter electrode is assembled, constant current discharge is performed at a current value of 10 mA per 1 g of a positive composite until the positive potential reaches 2.0 V vs. Li/Li⁺, and the positive electrode is adjusted to the completely discharged state. The battery is disassembled again, and the positive electrode is taken out. A nonaqueous electrolyte attached onto the taken out positive electrode is sufficiently washed with dimethyl carbonate and is dried at room temperature for an entire day and night, and the lithium transition metal composite oxide of the positive active material is then collected. The collected lithium transition metal composite oxide is subjected to measurement. Operations from disassembly to measurement of the nonaqueous electrolyte energy storage device are performed in an argon atmosphere having a dew point of −60° C. or lower. Here, the term “during normal usage” means use of the nonaqueous electrolyte energy storage device while employing charge-discharge conditions recommended or specified in the nonaqueous electrolyte energy storage device, and when a charger for the nonaqueous electrolyte energy storage device is prepared, this term means use of the nonaqueous electrolyte energy storage device by applying the charger.

The X-ray diffraction measurement for the lithium transition metal composite oxide is performed for the lithium transition metal composite oxide in the completely discharged state by the above method. Specifically, the X-ray diffraction measurement is performed by powder X-ray diffraction measurement using an X-diffraction device (“MiniFlex II” from Rigaku Corporation) under conditions such that a CuKα ray is used as a radiation source, a tube voltage is 30 kV, and a tube current is 15 mA. At this time, the diffracted X-ray passes through a KB filter having a thickness of 30 μm and is detected by a high-speed one-dimensional detector (D/teX Ultra 2). A sampling width is 0.02°, a scanning speed is 5°/min, a divergence slit width is 0.625°, a light receiving slit width is 13 mm (OPEN), and a scattering slit width is 8 mm.

A peak differential pore volume of the positive active material particles is preferably 0.5 mm³/(g nm) or less. By using the positive active material particles having a peak differential pore volume of 0.5 mm³/(g·nm) or less, the increase in the internal resistance associated with the charge-discharge cycle is further suppressed.

The peak differential pore volume of the positive active material particles is a value determined by a BJH method from an adsorption isotherm using a nitrogen gas adsorption method. Specifically, the peak differential pore volume is measured by the following method. 1.00 g of a powder of a measured sample (positive active material particles) is placed in a sample tube for measurement, and vacuum-dried at 120° C. for 12 hours to sufficiently remove moisture in the measured sample. Next, by a nitrogen gas adsorption method using liquid nitrogen, isotherms on the adsorption side and the extraction side are measured in a relative pressure P/P0 (P0=about 770 mmHg) range of 0 to 1. Then, a pore distribution is evaluated by calculation by the BJH method using the isotherm on the extraction side to determine the peak differential pore volume.

A content of manganese with respect to the transition metal in the lithium transition metal composite oxide is preferably 0.3 or more and 0.65 or less in terms of molar ratio. Heretofore, when such a lithium transition metal composite oxide containing a relatively high content of manganese is used, the increase in the internal resistance due to elution of manganese is particularly likely to occur. On the other hand, according to the nonaqueous electrolyte energy storage device according to one aspect of the present invention, even when the lithium transition metal composite oxide containing manganese in a content within the above range is used, the increase in the internal resistance associated with the charge-discharge cycle is sufficiently suppressed. By using the lithium transition metal composite oxide containing manganese in a content within the above range, the capacity retention ratio after the charge-discharge cycle can be increased.

It is preferable that at least a part of the aluminum is interspersed in a particulate manner on a surface of the positive active material particles. When aluminum is dispersed on the surface of the positive active material particles as described above, the increase in the internal resistance associated with the charge-discharge cycle is sufficiently suppressed. The positive active material particles in which aluminum is distributed as described above can be efficiently produced by firing a mixture containing a positive active material precursor, a lithium compound, and an aluminum compound, and are also excellent in productivity.

In the nonaqueous electrolyte energy storage device according to one aspect of the present invention, the positive electrode potential at the end-of-charge voltage under normal usage is preferably less than 4.5 V vs. Li/Li⁺. When the positive electrode potential at the end-of-charge voltage under normal usage is less than 4.5 V vs. Li/Li⁺, the change in the crystal structure in the direction in which the diffusion rate of lithium ions in the solid phase decreases is suppressed, so that the increase in the internal resistance associated with the charge-discharge cycle is more sufficiently suppressed. Furthermore, when the positive electrode potential at the end-of-charge voltage under normal usage is less than 4.5 V vs. Li/Li⁺, the temporal formation gradually proceeds with charge-discharge repeated many times, so that the capacity retention ratio can be further increased.

A method for using the nonaqueous electrolyte energy storage device according to another aspect of the present invention is a method for using the nonaqueous electrolyte energy storage device according to one aspect of the present invention, the method including charging at a positive electrode potential in a range of less than 4.5 V vs. Li/Li⁺.

According to the use method, the increase in the internal resistance associated with the charge-discharge cycle in the nonaqueous electrolyte energy storage device using the lithium-excess-type active material for the positive electrode is suppressed. According to the use method, the nonaqueous electrolyte energy storage device can be repeatedly used at a high capacity retention ratio.

A method for manufacturing a nonaqueous electrolyte energy storage device according to another aspect of the present invention is a method for manufacturing the nonaqueous electrolyte energy storage device according to one aspect of the present invention, the method including performing initial charge-discharge at a positive electrode potential in a range of less than 4.5 V vs. Li/Li⁺.

According to the manufacturing method, it is possible to manufacture a nonaqueous electrolyte energy storage device using a lithium-excess-type active material for a positive electrode, in which an increase in internal resistance associated with a charge-discharge cycle is suppressed. Furthermore, according to the manufacturing method, it is possible to manufacture a nonaqueous electrolyte energy storage device having a high capacity retention ratio in the charge-discharge cycle.

Another aspect of the present invention is an energy storage apparatus including two or more nonaqueous electrolyte energy storage devices, and one or more of the nonaqueous electrolyte energy storage devices according to another aspect of the present invention.

The energy storage apparatus according to one aspect of the present invention is an energy storage apparatus including one or more nonaqueous electrolyte energy storage devices using a lithium-excess-type active material for a positive electrode, in which an increase in internal resistance associated with a charge-discharge cycle is suppressed.

A method for using an energy storage device apparatus according to another aspect of the present invention is a method for using the energy storage apparatus according to one aspect of the present invention, the method including charging one or more of the nonaqueous electrolyte energy storage devices at a positive electrode potential in a range of less than 4.5 V vs. Li/Li⁺.

According to the use method, the increase in the internal resistance associated with the charge-discharge cycle in the energy storage apparatus including one or more nonaqueous electrolyte energy storage devices using the lithium-excess-type active material for the positive electrode is suppressed. According to the use method, the energy storage apparatus can be repeatedly used at a high capacity retention ratio.

A method for manufacturing an energy storage apparatus according to another aspect of the present invention is a method for manufacturing the energy storage apparatus according to one aspect of the present invention, the method including performing initial charge-discharge of one or more of the nonaqueous electrolyte energy storage devices at a positive electrode potential in a range of less than 4.5 V vs. Li/Li⁺.

According to the manufacturing method, it is possible to manufacture an energy storage apparatus including one or more nonaqueous electrolyte energy storage devices using a lithium-excess-type active material for a positive electrode, in which an increase in internal resistance associated with a charge-discharge cycle is suppressed. Furthermore, according to the manufacturing method, it is possible to manufacture an energy storage apparatus having a high capacity retention ratio in the charge-discharge cycle.

Hereinafter, the nonaqueous electrolyte energy storage device, the method for using the nonaqueous electrolyte energy storage device, and the method for manufacturing the nonaqueous electrolyte energy storage device according to an embodiment of the present invention will be described in detail.

<Nonaqueous Electrolyte Energy Storage Device>

The nonaqueous electrolyte energy storage device according to an embodiment of the present invention has a positive electrode, a negative electrode, and a nonaqueous electrolyte. The positive electrode and the negative electrode usually form an electrode assembly alternately superposed by stacking or winding with a separator interposed therebetween. The electrode assembly is housed in a case, and the case is filled with the nonaqueous electrolyte. The nonaqueous electrolyte is interposed between the positive electrode and the negative electrode. As the case, a known metal case or resin case or the like, which is usually used, can be used. Hereinafter, a nonaqueous electrolyte secondary battery (hereinafter, also simply referred to as a “secondary battery”) will be described as an example of the nonaqueous electrolyte energy storage device.

(Positive Electrode)

The positive electrode has a positive electrode substrate and a positive active material layer disposed directly or via an intermediate layer on the positive electrode substrate.

The positive electrode substrate has conductivity. Having “conductivity” means having a volume resistivity of 107 Ω·cm or less that is measured in accordance with JIS-H-0505 (1975), and the term “non-conductivity” means that the volume resistivity is more than 10⁷ Ω·cm. As the material of the positive electrode substrate, a metal such as aluminum, titanium, tantalum, or stainless steel, or an alloy thereof is used. Among these, aluminum or an aluminum alloy is preferable from the viewpoint of electric potential resistance, high conductivity, and costs. Examples of the positive electrode substrate include a foil and a deposited film, and a foil is preferable from the viewpoint of costs. Therefore, the positive electrode substrate is preferably an aluminum foil or an aluminum alloy foil. Examples of the aluminum or aluminum alloy include A1085 and A3003 specified in JIS-H-4000 (2014).

An average thickness of the positive electrode substrate is preferably 5 μm or more and 50 μm or less, and more preferably 10 μm or more and 40 μm or less. By setting the average thickness of the positive electrode substrate to be equal to or greater than the above lower limit, the strength of the positive electrode substrate can be increased. By setting the average thickness of the positive electrode substrate to be equal to or less than the above upper limit, the energy density per volume of the secondary battery can be increased. The “average thickness” refers to a value obtained by dividing the cutout mass in cutout of a substrate having a predetermined area by the true density and cutout area of the substrate. The same definition applies when the “average thickness” is used for other members and the like.

The intermediate layer is a layer arranged between the positive electrode substrate and the positive active material layer. The configuration of the intermediate layer is not particularly limited, and includes, for example, a resin binder and conductive particles. The intermediate layer contains, for example, conductive particles such as carbon particles to reduce contact resistance between the positive electrode substrate and the positive active material layer.

The positive active material layer is a layer of a positive composite containing positive active material particles. The positive active material layer (positive composite) may contain, in addition to the positive active material particles, optional components, such as a conductive agent, a binder, a thickener, and a filler, as necessary.

(Positive Active Material Particles)

The positive active material particles contain lithium transition metal composite oxide having an α-NaFeO₂ structure. The positive active material particles contain aluminum. Aluminum may be contained in the positive active material particles as a component constituting the lithium transition metal composite oxide, or may be contained in the positive active material particles as a component different from the lithium transition metal composite oxide.

A molar ratio (Li/Me) of a content of lithium (Li) to a transition metal (Me) in the lithium transition metal composite oxide is more than 1.0. This lithium transition metal composite oxide is a so-called lithium-excess-type active material. In the X-ray diffraction diagram of the lithium transition metal composite oxide using the CuKα ray, the diffraction peak is present in the range where the diffraction angle 2θ is 200 or more and 22° or less.

The transition metal (Me) contained in the lithium transition metal composite oxide contains at least one of nickel (Ni) and cobalt (Co), and manganese (Mn). The transition metal is preferably substantially composed of Ni and Mn or substantially composed of Ni, Mn and Co. The lithium transition metal composite oxide may be represented by Li_{1+α}(Ni_{β}Co_{γ}Mn_{δ})_{1-α}O₂ (0<α<1, 0≤β<1, 0≤γ<1, 0<δ<1, β+γ+δ=1, β+γ·0).

The content of lithium (Li) to the transition metal (Me) in the lithium transition metal composite oxide, that is, (1+α)/(1−α) is preferably 1.05 or more and 1.5 or less, more preferably 1.1 or more and 1.4 or less, and further preferably 1.2 or more and 1.35 or less in some cases. When (1+α)/(1−α) is within the above range, performance as a lithium-excess-type active material such as a large discharge capacity is sufficiently exhibited, and the increase in the internal resistance of the secondary battery (nonaqueous electrolyte energy storage device) associated with the charge-discharge cycle is further suppressed. The content (content ratio) of each element in the lithium transition metal composite oxide is an atomic ratio and is equal to the molar ratio.

A content (Ni/Me) of Ni to the transition metal (Me) in the lithium transition metal composite oxide, that is, B may be, for example, 0.1 or more and 0.8 or less, and is preferably 0.2 or more and 0.7 or less, and more preferably 0.3 or more and 0.6 or less. By setting Ni/Me to be equal to or greater than the above lower limit, output performance, energy density, and the like can be enhanced. By setting Ni/Me to be equal to or less than the above upper limit, the capacity retention ratio and the like can be increased.

A content (Co/Me) of Co to the transition metal (Me) in the lithium transition metal composite oxide, that is, γ may be, for example, 0 or more and 0.6 or less, and may be 0.1 or more and 0.3 or less. By setting Co/Me to be equal to or greater than the above lower limit, the output performance, the energy density, and the like can be enhanced. On the other hand, by setting Co/Me to be equal to or less than the above upper limit, it is possible to suppress the raw material cost while exhibiting a sufficient capacity retention ratio.

A molar ratio (Mn/Me) of Mn to the transition metal (Me) in the lithium transition metal composite oxide, that is, δ may be, for example, 0.1 or more and 0.8 or less, and is preferably 0.3 or more and 0.65 or less. By setting Mn/Me to be equal to or greater than the above lower limit, the action of temporal formation is enhanced, and the capacity retention ratio can be increased. By setting Mn/Me to be equal to or less than the above upper limit, elution of Mn can be suppressed, the increase in the internal resistance of the secondary battery associated with the charge-discharge cycle can be further suppressed, and the output performance and the like are also enhanced.

The lithium transition metal composite oxide may contain other transition metals and the like as long as the effect of the present invention is exhibited, and other transition metals and the like may be mixed as impurities. The lithium transition metal composite oxide may contain aluminum as described above. The lithium transition metal composite oxide containing aluminum may be represented by, for example, Li_{1+α}(Ni_{β}Co_{γ}Mn_{δ}Al_{ε})_{1-α}O₂ (0<α<1, 0≤β<1, 0≤γ<1, 0<δ<1, 0<ε<0.2, β+γ+δ+ε=1, β+γ≠0).

The positive active material particles may contain a positive active material other than the lithium transition metal composite oxide. The other positive active material can be appropriately selected from known positive active materials usually used for lithium ion secondary batteries and the like. As the other positive active material, a material capable of occluding and releasing lithium ions is usually used. Examples thereof include the LiMeO₂-type active material described above, lithium transition metal oxides having a spinel-type crystal structure, polyanion compounds, chalcogenides, and sulfur. However, the content of the lithium transition metal composite oxide (lithium-excess-type active material) in the whole positive active material contained in the positive active material particles is preferably 80% by mass or more, more preferably 90% by mass or more, further preferably 99% by mass or more, and even more preferably 100% by mass.

Aluminum is preferably present on at least the surface of the positive active material particles. For example, when the positive active material particles are secondary particles, aluminum is preferably present on at least the surface of the secondary particles. However, aluminum may be present between primary particles of the positive active material particles. Aluminum may be solid-solved in the positive active material.

Aluminum may be present so as to cover the entire surface of the positive active material particles, or may be interspersed in a particulate manner on the surface of the positive active material particles. However, it is preferable that at least a part of aluminum is interspersed in a particulate manner on the surface of the positive active material particles, that is, at least a part of aluminum is dispersed in a particulate manner on the surface of the positive active material particles from the viewpoint of productivity, suppression properties of the increase in the internal resistance, and the like. At this time, particles containing aluminum may be bonded to each other. In addition to aluminum present on the surface of the positive active material particles, aluminum may be present in a portion other than the surface of the positive active material particles, that is, inside the positive active material particles. A positive active material such as a lithium transition metal composite oxide containing aluminum is used, and this aluminum may be present on the particle surface.

In an embodiment of the present invention, aluminum is present on the surface of the positive active material particles in the form of a compound, more preferably in the form of compound particles. Examples of the compound of aluminum include oxides, sulfides, halides, silicates, phosphates, sulfates, nitrates, and alloys. Among them, aluminum is preferably present as an oxide (Al₂O₃, LiAlO₂, etc.).

The content of aluminum in the positive active material particles may be, for example, 0.01 mol % or more and 5 mol % or less, and is preferably 0.1 mol % or more and 2.5 mol % or less, and more preferably 0.3 mol % or more and 1.5 mol % or less, with respect to the transition metal in the lithium transition metal composite oxide. By setting the content of aluminum to be equal to or greater than the above lower limit, a manganese elution suppression action due to the presence of aluminum in the positive active material particles is enhanced, and the increase in the internal resistance of the secondary battery associated with the charge-discharge cycle can be further suppressed. On the other hand, by setting the content of aluminum to be equal to or less than the above upper limit, the amount of the positive active material relatively increases, and therefore, the energy density and the like can be increased.

Here, the content of aluminum in the positive active material particles is a value measured by ICP (inductively coupled plasma) emission spectrometry.

The peak differential pore volume of the positive active material particles is not particularly limited, may be 0.01 mm³/(g·nm) or more and 2 mm³/(g·nm) or less, and is preferably 0.02 mm³/(g·nm) or more and 0.5 mm³/(g·nm) or less, more preferably 0.3 mm³/(g·nm) or less. When the peak differential pore volume is relatively small as described above, a lithium transition metal composite oxide having a relatively high density is obtained, and the energy density of the secondary battery can be increased. By using the positive active material particles having a peak differential pore volume of equal to or less than the above upper limit, the increase in the internal resistance associated with the charge-discharge cycle is further suppressed. The positive active material particles having a peak differential pore volume of, for example, 0.5 mm³/(g·nm) or less can be obtained, for example, by using a hydroxide precursor to be described later as the positive active material precursor.

The average particle size of the positive active material particles is preferably 0.1 μm or more and 20 μm or less, for example. By setting the average particle size of the positive active material particles to be equal to or greater than the above lower limit, the positive active material particles are easily produced or handled. By setting the average particle size of the positive active material particles to be equal to or less than the above upper limit, the electron conductivity of the positive active material layer is improved. Here, the term “average particle size” means a value at which a volume-based integrated distribution calculated in accordance with KIS-Z-8819-2 (2001) is 50% based on a particle size distribution measured by a laser diffraction/scattering method for a diluted solution obtained by diluting particles with a solvent in accordance with JIS-Z-8825 (2013).

The content of the positive active material particles in the positive active material layer (positive composite) is preferably 70% by mass or more and 98% by mass or less, more preferably 80% by mass or more and 97% by mass or less, further preferably 90% by mass or more and 96% by mass or less. By setting the content of the positive active material particles within the above range, an electric capacity of the secondary battery can be increased.

(Method of Producing Positive Active Material Particles)

In the positive active material particles containing aluminum, examples include (1) a method in which a particulate positive active material is added to a liquid obtained by dissolving or suspending an aluminum compound (compound containing aluminum) and then dried, (2) a method in which a particulate positive active material is added to a liquid obtained by dissolving or suspending an aluminum compound and then reacted by heating or the like, (3) a method in which a mixture containing a positive active material precursor, a lithium compound, and an aluminum compound is fired, (4) a method in which a mixture containing an aluminum compound and a particulate positive active material is fired, and (5) a method in which a mixture containing a positive active material precursor containing aluminum and a lithium compound is fired. Among these methods, (3) the method in which the mixture containing the positive active material precursor, the lithium compound, and the aluminum compound is fired is preferable. By producing the positive active material particles by such a method, it is possible to efficiently obtain the above-described positive active material particles in which at least a part of aluminum or an aluminum compound is interspersed in a particulate manner on the surface. In the positive active material particles, for example, aluminum may be present between the primary particles, a part of aluminum may be solid-solved, or particulate aluminum particles may be bonded to each other. In the case of the method using the liquid in which an aluminum compound is dissolved or suspended as in the above (1) and (2), usually, a coating layer containing the aluminum compound is formed on the surface of a particulate positive active material, and it is difficult to obtain positive active material particles in which particulate aluminum or the aluminum compound is interspersed on the surface. Hereinafter, a method of producing positive active material particles according to the method (3) will be described in detail.

The lithium transition metal composite oxide can be usually obtained by preparing a raw material containing metal elements (Li, Ni, Mn, etc.) in accordance with the composition of a desired lithium transition metal composite oxide and firing the raw material. For preparation of a lithium transition metal composite oxide having a desired composition, a so-called “solid phase method” in which salts of Li, Ni, Mn, and the like are mixed and fired, and a “coprecipitation method” in which a coprecipitation precursor with Ni, Mn, and the like made to be present in one particle is prepared in advance, and a Li salt is mixed therewith and fired are known. Among these methods, the coprecipitation method in which it is easy to obtain a target product in which each element is distributed with high uniformity is preferable. Hereinafter, the coprecipitation method will be described.

Examples of the precursor (positive active material precursor) obtained by the coprecipitation method generally include a hydroxide precursor and a carbonate precursor. Particularly, a method of producing a hydroxide precursor is preferable because positive active material particles having a small peak differential pore volume and capable of sufficiently suppressing the increase in the internal resistance associated with the charge-discharge cycle can be obtained.

In the case of producing a hydroxide precursor, it is preferable to add an alkali solution containing an alkali metal hydroxide (neutralizing agent), a complexing agent, and a reducing agent together with a solution containing a transition metal (Me) to water (aqueous solution) in a reaction tank maintaining alkalinity to coprecipitate a transition metal hydroxide as a hydroxide precursor. As the complexing agent, ammonia, ammonium sulfate, ammonium nitrate or the like can be used. As the reducing agent, hydrazine, sodium borohydride, or the like can be used. As the alkali metal hydroxide, sodium hydroxide, lithium hydroxide, potassium hydroxide, or the like can be used.

In the case of producing a carbonate precursor, it is preferable to add an alkali solution containing a neutralizing agent such as sodium carbonate or lithium carbonate and a complexing agent together with a solution containing a transition metal (Me) to water (aqueous solution) in a reaction tank maintaining alkalinity to coprecipitate a transition metal carbonate as a carbonate precursor.

Regarding the raw material of the precursor, examples of the Ni compound include nickel hydroxide, nickel carbonate, nickel sulfate, nickel nitrate, and nickel acetate. Examples of the Co compound include cobalt sulfate, cobalt nitrate, and cobalt acetate. Examples of the Mn compound include manganese oxide, manganese carbonate, manganese sulfate, manganese nitrate, and manganese acetate.

In preparation of a precursor, since Mn is easily oxidized, for example, it is not easy to prepare a precursor in which Ni, Co and Mn are uniformly distributed in a divalent state, and thus uniform mixing of Ni, Co and Mn at an atomic level is likely to be insufficient. Therefore, in order to suppress the oxidation of Mn present in the precursor, it is preferable to remove water or dissolved oxygen in the solution. Examples of the method for removing dissolved oxygen include a method in which the solution is bubbled using a gas free of oxygen. The gas free of oxygen is not particularly limited, and examples of the gas include nitrogen gas, argon gas, and carbon dioxide gas.

When a precursor is prepared by coprecipitating a compound containing a transition metal in a solution, pH of the solution, a dropwise addition rate of a raw material aqueous solution, and the like are not particularly limited, and conditions similar to conventionally known production conditions can be employed. The pH of the solution can be, for example, 8 to 11, and may be 9.5 to 10.5. The dropwise addition rate of the raw material aqueous solution may be, for example, 0.1 cm³/min or more and 10 cm³/min or less.

When a complexing agent such as NH₃ is present in the reaction tank, and certain convection conditions are applied, rotation and revolution, in a stirring tank, of particles are promoted by further continuing stirring after completion of dropwise addition of the raw material aqueous solution, and in this process, the particles are grown stepwise into a concentric circular sphere while colliding with one another. That is, a coprecipitation precursor is formed through reactions in two stages, i.e. a metal complex formation reaction when the raw material aqueous solution is added dropwise into the reaction tank and a precipitate formation reaction that occurs during retention of the metal complex in the reaction tank.

The preferred stirring duration after the end of dropwise addition of the raw material aqueous solution, that is, the reaction time depends on the size of a reaction tank, stirring conditions, the pH, the reaction temperature and the like, and the stirring duration is, for example, preferably 0.5 hours or more and 20 hours or less, and more preferably 1 hour or more and 15 hours or less.

The precursor (positive active material precursor) obtained by the above method, a Li compound, and an aluminum compound are mixed and fired to obtain positive active material particles. As the Li compound, lithium hydroxide, lithium carbonate, or the like can be used. In addition to these Li compounds, LiF, Li₂SO₄, or Li₃PO₄ can be used as a sintering aid. The ratio of such a sintering aid added is preferably 1 to 10 mol % based on the total amount of the Li compounds. The total amount of the Li compounds is preferably excessive by about 1 to 5 mol % in anticipation of loss of a part of the Li compounds during firing. Examples of the aluminum compound include oxides, sulfides, halides, silicates, phosphates, sulfates, nitrates, and alloys, and oxides are preferable.

The firing temperature is preferably 750° C. or higher and 1,000° C. or lower. By setting the firing temperature to be equal to or greater than the above lower limit, positive active material particles having a high degree of sintering can be obtained, and charge-discharge cycle performance can be improved. On the other hand, by setting the firing temperature to be equal to or less than the above upper limit, it is possible to suppress a decrease in discharge performance due to, for example, a structural change from a layered α-NaFeO₂ structure to a rock salt type cubic crystal structure.

A crusher, a classifier, and the like are used to obtain particles such as positive active material particles in a predetermined shape. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

(Components Other than Positive Active Material Particles)

The conductive agent is not particularly limited as long as it is a material exhibiting conductivity. Examples of such a conductive agent include: graphite; carbon blacks such as furnace black and acetylene black; metals; and conductive ceramics. Examples of the shape of the conductive agent include a powdery shape and a fibrous shape. Among these, acetylene black is preferable from the viewpoint of electron conductivity and coatability.

The content of the conductive agent in the positive active material layer (positive composite) is preferably 1% by mass or more and 10% by mass or less, and more preferably 2% by mass or more and 5% by mass or less. By setting the content of the conductive agent within the above range, the electric capacity of the secondary battery can be increased.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

The content of the binder in the positive active material layer (positive composite) is preferably 1% by mass or more and 10% by mass or less, and more preferably 2% by mass or more and 5% by mass or less. When the content of the binder is within the above-described range, the active material can be stably held.

Examples of the thickener include polysaccharide polymers such as carboxymethylcellulose (CMC) and methylcellulose. When the thickener has a functional group reactive with lithium and the like, the functional group may be deactivated by methylation or the like in advance.

The filler is not particularly limited. Examples of the filler include polyolefins such as polypropylene and polyethylene, silica, alumina, zeolite, glass, and alumina silicate.

The positive active material layer may contain a typical nonmetal element such as B, N, P, F, Cl, Br, or I, a typical metal element such as Li, Na, Mg, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material particles, the conductive agent, the binder, the thickener, and the filler.

(Negative Electrode)

The negative electrode has a negative electrode substrate and a negative active material layer disposed directly or via an intermediate layer on the negative electrode substrate. The configuration of the intermediate layer of the negative electrode is not particularly limited, and the intermediate layer can have the same configuration as that of the intermediate layer of the positive electrode.

The negative electrode substrate exhibits conductivity. As the material of the negative electrode substrate, a metal such as copper, nickel, stainless steel, nickel-plated steel, or aluminum, or an alloy thereof is used. Among them, copper or a copper alloy is preferable. Examples of the negative electrode substrate include a foil and a vapor deposited film, and a foil is preferable from the viewpoint of cost. Therefore, the negative electrode substrate is preferably a copper foil or a copper alloy foil. Examples of the copper foil include a rolled copper foil and an electrolytic copper foil.

An average thickness of the negative electrode substrate is preferably 3 μm or more and 30 μm or less, and more preferably 5 μm or more and 20 μm or less. By setting the average thickness of the negative electrode substrate to be equal to or greater than the above lower limit, the strength of the negative electrode substrate can be increased. By setting the average thickness of the negative electrode substrate to be equal to or less than the above upper limit, the energy density per volume of the secondary battery can be increased.

The negative active material layer is a layer of a negative composite containing a negative active material. The negative active material layer (negative composite) may contain, in addition to the negative active material, optional components, such as a conductive agent, a binder, a thickener, and a filler, as necessary. As the optional components such as a conductive agent, a binder, a thickener, and a filler, the same components as those in the positive active material layer can be used. The contents of these optional components in the negative active material layer can be within the ranges described as the contents of the components in the positive active material layer.

The negative active material can be appropriately selected from known negative active materials. As the negative active material for a lithium ion secondary battery, a material capable of absorbing and releasing lithium ions is usually used. Examples of the negative active material include: metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). In the negative active material layer, one of these materials may be used singly, or two or more of these materials may be mixed and used.

The term “graphite” refers to a carbon material in which an average grid distance (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice distance (d₀₀₂) of the (002) plane determined by the X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

Here, the “discharged state” defining graphite and non-graphite carbon refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge and discharge are sufficiently released from the carbon material that is the negative active material.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

In order to obtain a secondary battery having a high capacity retention ratio, the negative active material is preferably a carbon material, and more preferably graphite. When a carbon material is used as the negative active material, the content of the carbon material in all the negative active materials may be 50% by mass or more, 70% by mass or more, 90% by mass or more, or substantially 100% by mass.

The negative active material is usually particles (powder). The average particle size of the negative active material can be, for example, 1 nm or more and 100 μm or less. By setting the average particle size of the negative active material to be equal to or greater than the above lower limit, the negative active material is easily produced or handled. By setting the average particle size of the negative active material to be equal to or less than the above upper limit, the electron conductivity of the positive active material layer is improved. A crusher, a classifier, and the like are used to obtain a powder having a predetermined particle size. A crushing method and a powder classification method can be selected from, for example, the methods exemplified for the positive electrode.

The content of the negative active material in the negative active material layer (negative composite) is preferably 60% by mass or more and 99% by mass or less, and more preferably 90% by mass or more and 98% by mass or less. When the content of the negative active material is in the above range, it is possible to achieve both high energy density and productivity of the negative active material layer.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

(Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of a material of the substrate layer of the separator include a woven fabric, a nonwoven fabric, and a porous resin film. Among these materials, a porous resin film is preferable from the viewpoint of strength, and a nonwoven fabric is preferable from the viewpoint of liquid retention property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles contained in the heat resistant layer preferably have a mass loss of 5% or less at 500° C. in the atmosphere, and more preferably have a mass loss of 5% or less at 800° C. in the atmosphere. Inorganic compounds can be mentioned as materials whose mass loss is a predetermined value or less. Examples of the inorganic compound include oxides such as iron oxide, silicon oxide, aluminum oxide, titanium dioxide, barium titanate, zirconium oxide, calcium oxide, strontium oxide, barium oxide, magnesium oxide and aluminosilicate; hydroxides such as magnesium hydroxide, calcium hydroxide and aluminum hydroxide; nitrides such as aluminum nitride and silicon nitride; carbonates such as calcium carbonate; sulfates such as barium sulfate; hardly soluble ionic crystals of calcium fluoride, barium fluoride, and the like; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more kinds thereof may be mixed and used. Among these inorganic compounds, silicon oxide, aluminum oxide, or aluminosilicate is preferable from the viewpoint of safety of the secondary battery.

A porosity of the separator is preferably 80 vol % or less from the viewpoint of strength, and is preferably 20 vol % or more from the viewpoint of discharge performance. Here, the “porosity” is a volume-based value, and means a value measured with a mercury porosimeter.

As the separator, a polymer gel composed of a polymer and a nonaqueous electrolyte may be used. Examples of the polymer include polyacrylonitrile, polyethylene oxide, polypropylene oxide, polymethyl methacrylate, polyvinyl acetate, polyvinylpyrrolidone, and polyvinylidene fluoride. The use of polymer gel has the effect of suppressing liquid leakage. As the separator, a polymer gel may be used in combination with a porous resin film, a nonwoven fabric, or the like as described above.

(Nonaqueous Electrolyte)

The nonaqueous electrolyte can be appropriately selected from known nonaqueous electrolytes. As the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used. For example, by using a fluorinated compound (fluorinated cyclic carbonate, fluorinated chain carbonate, etc.), it can be sufficiently used even under use conditions where the positive electrode potential reaches a high potential.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these, EC, PC, and FEC are preferable.

Examples of the chain carbonate include diethyl carbonate (DEC), dimethyl carbonate (DMC), ethyl methyl carbonate (EMC), diphenyl carbonate, methyl trifluoroethyl carbonate (MFEC), and bis(trifluoroethyl)carbonate. Among these, EMC and MFEC are preferable.

As the nonaqueous solvent, it is preferable to use the cyclic carbonate or the chain carbonate, and it is more preferable to use the cyclic carbonate and the chain carbonate in combination. By using the cyclic carbonate, dissociation of the electrolyte salt can be promoted to improve ionic conductivity of the nonaqueous electrolyte solution. By using the chain carbonate, viscosity of the nonaqueous electrolyte solution can be suppressed to be low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among them, the lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F), LiC(SO₂CF₃)₃ and LiC(SO₂C₂F₅)₃. Among these, an inorganic lithium salt is preferable, and LiPF₆ is more preferable.

The content of the electrolyte salt in the nonaqueous electrolyte solution is preferably 0.1 mol/dm³ or more and 2.5 mol/dm³ or less, more preferably 0.3 mol/dm³ or more and 2.0 mol/dm³ or less, further preferably 0.5 mol/dm³ or more and 1.7 mol/dm³ or less, and particularly preferably 0.7 mol/m³ or more and 1.5 mol/dm³ or less. When the content of the electrolyte salt is within the above range, the ionic conductivity of the nonaqueous electrolyte solution can be increased.

The nonaqueous electrolyte solution may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more may be mixed and used.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte solution. When the content of the additive is within the above range, it is possible to improve capacity retention performance or cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material having ionic conductivity such as lithium, sodium and calcium and being solid at room temperature (for example, 15° C. or higher and 25° C. or lower). Examples of the solid electrolyte include sulfide solid electrolytes, oxide solid electrolytes, oxynitride solid electrolytes, and polymer solid electrolytes.

Examples of the lithium ion secondary battery include Li₂S—P₂S₅, LiI—Li₂S—P₂S₅, and Li₁₀Ge—P₂S₁₂ as the sulfide solid electrolyte.

(Positive Electrode Potential at End-of-Charge Voltage Under Normal Usage)

In the secondary battery (nonaqueous electrolyte energy storage device), the positive electrode potential (positive electrode achieved potential) at the end-of-charge voltage under normal usage is not particularly limited, and is preferably less than 4.5 V vs. Li/Li⁺, more preferably less than 4.45 V vs. Li/Li⁺, and further preferably less than 4.4 V vs. Li/Li⁺ in some cases. By setting the positive electrode potential at the end-of-charge voltage under normal usage to be equal to or less than the above upper limit, the increase in the internal resistance associated with the charge-discharge cycle is sufficiently suppressed. In addition, by setting the positive electrode potential at the end-of-charge voltage under normal usage to be equal to or less than the above upper limit, the temporal formation proceeds gradually, so that the capacity retention ratio can be increased.

In the secondary battery, the positive electrode potential at the end-of-charge voltage under normal usage is preferably more than 4.25 V vs. Li/Li⁺, more preferably 4.3 V vs. Li/Li⁺ or more, and further preferably 4.35 V vs. Li/Li⁺ or more in some cases. By setting the positive electrode potential at the end-of-charge voltage under normal usage to be equal to or greater than the above lower limit, the discharge capacity can be increased, and the energy density, the output performance, and the like can be enhanced. By setting the positive electrode potential at the end-of-charge voltage under normal usage to be equal to or greater than the above lower limit, the temporal formation sufficiently proceeds during normal charge, so that the capacity retention ratio can be increased.

The positive electrode potential at the end-of-charge voltage under normal usage in the secondary battery may be within a range between any of the above upper limits and any of the above lower limits.

<Method for Using Nonaqueous Electrolyte Energy Storage Device>

The method for using the secondary battery (nonaqueous electrolyte energy storage device) according to an embodiment of the present invention is not particularly limited, and the following method is preferable. That is, the method for using the secondary battery according to an embodiment of the present invention includes charging the secondary battery in a range in which a positive electrode potential (positive electrode achieved potential) is less than 4.5 V vs. Li/Li⁺. According to the use method, the increase in the internal resistance associated with the charge-discharge cycle in the secondary battery using the lithium-excess-type active material for the positive electrode is suppressed. According to the use method, the secondary battery can be repeatedly used at a high capacity retention ratio.

The upper limit of the positive electrode potential (positive electrode achieved potential) in this charge is more preferably less than 4.45 V vs. Li/Li⁺, and further preferably less than 4.4 V vs. Li/Li⁺ in some cases. The lower limit of the positive electrode potential in this charge is preferably more than 4.25 V vs. Li/Li⁺, more preferably 4.3 V vs. Li/Li⁺ or more, and further preferably 4.35 V vs. Li/Li⁺ or more in some cases.

This use method may be the same as a conventionally known method for using a secondary battery except that the positive electrode potential (positive electrode achieved potential) in the charge is set as described above.

<Method for Manufacturing Nonaqueous Electrolyte Energy Storage Device>

A method for manufacturing a secondary battery (nonaqueous electrolyte energy storage device) according to an embodiment of the present invention includes assembling an uncharged and undischarged nonaqueous electrolyte energy storage device including a positive electrode, a negative electrode, and a nonaqueous electrolyte, and initially charging and discharging the uncharged and undischarged nonaqueous electrolyte energy storage device. In this initial charge-discharge, the initial charge-discharge is performed in a range in which the positive electrode potential (positive electrode achieved potential) is less than 4.5 V vs. Li/Li⁺. The positive electrode includes the above-described positive active material particles. According to the manufacturing method, it is possible to manufacture a secondary battery using a lithium-excess-type active material for the positive electrode, in which the increase in the internal resistance associated with the charge-discharge cycle is suppressed. Furthermore, according to the manufacturing method, it is possible to manufacture a secondary battery having a high capacity retention ratio in the charge-discharge cycle.

In the manufacturing method, the initial charge-discharge does not actively activate the lithium-excess-type active material, and may be performed, for example, for confirming the capacity. That is, the initial charge-discharge is simply charge-discharge performed for the first time after assembling the uncharged and undischarged nonaqueous electrolyte energy storage device. The number of times of charge and discharge in the initial charge-discharge may be 1 or 2, or may be 3 or more.

The upper limit of the positive electrode potential (positive electrode achieved potential) in the initial charge-discharge is less than 4.45 V vs. Li/Li⁺, and less than 4.4 V vs. Li/Li⁺ in some cases. On the other hand, the lower limit of the positive electrode potential in the initial charge-discharge is not particularly limited, and may be, for example, more than 4.25 V vs. Li/Li⁺, and may be 4.3 V vs. Li/Li⁺ or more, or 4.35 V vs. Li/Li⁺ or more.

Assembling the uncharged and undischarged nonaqueous electrolyte energy storage device including the positive electrode, the negative electrode, and the nonaqueous electrolyte includes, for example, preparing an electrode assembly, preparing a nonaqueous electrolyte, and housing the electrode assembly and the nonaqueous electrolyte in a case. The preparation of the electrode assembly includes: preparing a positive electrode, preparing a negative electrode, and forming an electrode assembly by stacking or winding the positive electrode and the negative electrode with a separator interposed therebetween.

The positive electrode can be prepared by applying a positive composite paste to a positive electrode substrate directly or via an intermediate layer, followed by drying. The positive composite paste contains components constituting a positive active material layer (positive composite) such as positive active material particles, and a dispersion medium. A preferred method of producing the positive active material particles is as described above. That is, the method for manufacturing the secondary battery or the preparation of the positive electrode preferably includes obtaining the positive active material particles by firing a mixture containing a positive active material precursor, a lithium compound, and an aluminum compound.

The negative electrode can be prepared, for example, by applying a negative composite paste to a negative electrode substrate directly or via an intermediate layer, followed by drying. The negative composite paste contains components constituting a negative active material layer (negative composite) such as a negative active material, and a dispersion medium.

### OTHER EMBODIMENTS

The nonaqueous electrolyte energy storage device of the present invention is not limited to the embodiments described above, and various changes may be made without departing from the gist of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be removed. In addition, a well-known technique can be added to the configuration according to one embodiment.

In the above-described embodiments, an embodiment in which the nonaqueous electrolyte energy storage device is a nonaqueous electrolyte secondary battery has been mainly described, but the nonaqueous electrolyte energy storage device may be other nonaqueous electrolyte energy storage device. Examples of the other nonaqueous electrolyte energy storage device include capacitors (electric double layer capacitors and lithium ion capacitors).

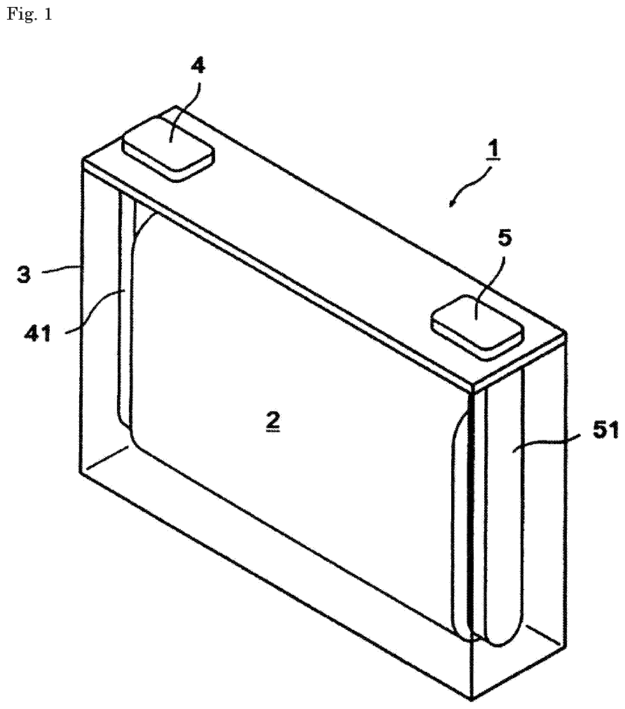

FIG. 1 is a schematic view of a rectangular nonaqueous electrolyte energy storage device 1 (nonaqueous electrolyte secondary battery), which is an embodiment of the nonaqueous electrolyte energy storage device according to the present invention. FIG. 1 is a view showing an inside of a case in a perspective manner. In the nonaqueous electrolyte energy storage device 1 shown in FIG. 1, an electrode assembly 2 is housed in a case 3. The electrode assembly 2 is formed by winding a positive electrode provided with a positive active material and a negative electrode provided with a negative active material via a separator. The positive electrode is electrically connected to a positive electrode terminal 4 through a positive electrode lead 41, and the negative electrode is electrically connected to a negative electrode terminal 5 through a negative electrode lead 51.

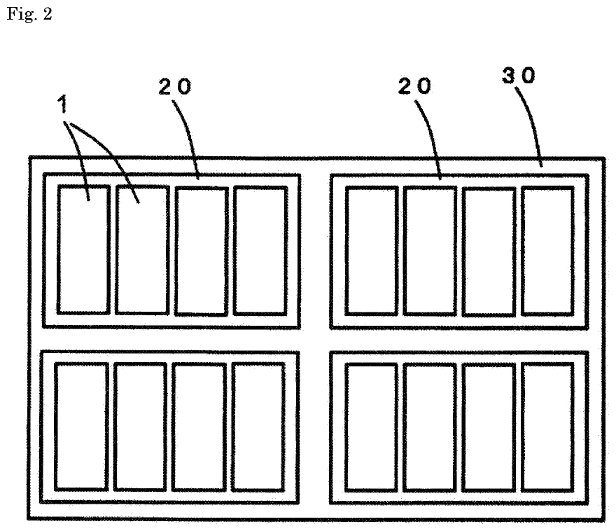

The configuration of the nonaqueous electrolyte energy storage device according to the present invention is not particularly limited, and examples thereof include cylindrical batteries, prismatic batteries (rectangular batteries), and flat batteries. The energy storage apparatus according to an embodiment of the present invention includes two or more nonaqueous electrolyte energy storage devices and one or more nonaqueous electrolyte energy storage devices according to the above embodiment (hereinafter referred to as “second embodiment”). The technique according to one embodiment of the present invention may be applied to at least one nonaqueous electrolyte energy storage device included in the energy storage apparatus according to the second embodiment, one nonaqueous electrolyte energy storage device according to the above embodiment may be provided, and one or more nonaqueous electrolyte energy storage devices not according to the above embodiment may be provided, or two or more nonaqueous electrolyte energy storage devices according to the above embodiment may be provided. FIG. 2 shows an embodiment of the energy storage apparatus according to the second embodiment. In FIG. 2, an energy storage apparatus 30 according to the second embodiment includes a plurality of energy storage units 20. Each of the energy storage units 20 includes a plurality of the nonaqueous electrolyte energy storage devices 1. The energy storage apparatus 30 can be mounted as a power source for an automobile such as an electric vehicle (EV), a plug-in hybrid vehicle (PHEV), or the like.

### EXAMPLES

Hereinafter, the present invention will be described in more detail with reference to Examples, but the present invention is not limited to the following Examples.

### Example 1

(Preparation of Hydroxide Precursor)

315.4 g of nickel sulfate hexahydrate, 168.6 g of cobalt sulfate heptahydrate, and 530.4 g of manganese sulfate pentahydrate were weighed. All of these were dissolved in 4 dm³ of ion-exchange water to prepare a 1.0 mol/dm³ aqueous sulfate solution of which the molar ratio of Ni:Co:Mn was 30:15:55. Next, 2 dm³ of ion-exchange water was poured into a 5 dm³ reaction tank, and bubbled with nitrogen gas for 30 minutes to remove oxygen contained in the ion-exchange water. The temperature of the reaction tank was set to 50° C. (±2° C.), and an arrangement was made so as to sufficiently generate a conviction flow in the reaction layer while the contents of the reaction tank was stirred at a rotation speed of 1,500 rpm using a paddle impeller equipped with a stirring motor. The sulfate stock solution was added dropwise to the reaction tank at a rate of 1.3 cm³/min for 50 hours. Here, during a period between the start and the end of dropwise addition, a mixed alkali solution including 4.0 mol/dm³ of sodium hydroxide, 1.25 mol/dm3 of ammonia, and 0.1 mol/km³ of hydrazine was appropriately added dropwise to perform control so that the pH in the reaction tank was 10.20 (±0.1) on a constant basis, and a part of the reaction liquid was discharged by overflow to perform control so that the total amount of the reaction liquid was not more than 2 dm³ on a constant basis. After the end of the dropwise addition, stirring in the reaction tank was further continued for 1 hour. After the stirring was stopped, the mixture was allowed to stand at room temperature for 12 hours or more. Next, hydroxide precursor particles generated in the reaction tank were separated using a suction filtration apparatus, and washed with ion-exchange water to remove sodium ions deposited on the particles. The hydroxide precursor particles were dried at 80° C. for 20 hours under normal pressure in an air atmosphere using an electric furnace. Thereafter, for equalizing the particle sizes, the particles were ground for several minutes in an automatic mortar made of agate. In this way, the hydroxide precursor of which the molar ratio of Ni:Co:Mn was 30:15:55 was obtained.

(Preparation of Positive Active Material Particles)

Lithium hydroxide monohydrate and aluminum oxide Al₂O₃ were added to the obtained hydroxide precursor, and using an automatic mortar made of agate, the mixture was adequately stirred to prepare a mixed powder of which the molar ratio (Li/Me) of Li/(Ni, Co, Mn) was 1.1. The ratio of aluminum oxide added was adjusted so that the molar ratio (Al/Me) of Al/(Ni, Co, Mn) was 0.005. The mixed powder was pelletized. The pellet was placed on an alumina boat, using a box-shaped electric furnace (model number: AMF 20), the temperature was raised from room temperature to 900° C. over 10 hours under normal pressure in an air atmosphere, and firing was performed at 900° C. for 4 hours. After the firing, the heater was turned off, and the alumina boat was allowed to cool naturally while being left to stand in the furnace. As a result, although the temperature of the furnace decreased to about 200° C. after 5 hours, the subsequent temperature decrease rate was slightly low. After a lapse of an entire day and night, the temperature of the furnace was confirmed to be 60° C. or lower, and the pellets were then taken out, and ground for several minutes with an automatic mortar made of agate for equalizing the particle sizes.

In this way, positive active material particles containing a lithium transition metal composite oxide (Ni:Co:Mn=30:15:55, Li/Me=1.1) were prepared. The obtained positive active material particles were subjected to powder X-ray diffraction measurement using an X-ray diffractometer (manufactured by Rigaku Corporation, model name: MiniFlex II). It was confirmed that the lithium transition metal composite oxide in the obtained positive active material particles had an α-NaFeO₂ structure, and that there was a diffraction peak in the range of 20° or more and 22° or less in the X-ray diffraction diagram.

The peak differential pore volume of the obtained positive active material particles was measured by the method described above, and the value was 0.038 mm³/(g nm).

(Fabrication of Positive Electrode)

A positive composite paste was produced, which contained the obtained positive active material particles, acetylene black (AB), and polyvinylidene fluoride (PVDF) at a mass ratio of 90:5:5 (in terms of solid matter) with N-methylpyrrolidone (NMP) as a dispersion medium. This positive composite paste was applied to an aluminum foil (thickness: 15 μm) as a positive electrode substrate, and dried to obtain a positive electrode.

(Fabrication of Negative Electrode)

A negative composite paste was produced, which contained graphite as a negative active material, styrene butadiene rubber (SBR), and carboxymethyl cellulose (CMC) at a mass ratio of 96:3.2:0.8 (in terms of solid content) with water as a dispersion medium. This negative composite paste was applied to a strip-shaped copper foil (thickness: 10 μm) as a negative electrode substrate, and dried to obtain a negative electrode.

(Assembly of Test Battery)

A test battery (nonaqueous electrolyte energy storage device) using the positive electrode and the negative electrode was assembled. As a nonaqueous electrolyte, a solution obtained by dissolving lithium hexafluorophosphate (LiPF₆) as an electrolyte salt in a nonaqueous solvent obtained by mixing EC (ethylene carbonate), EMC (ethylmethyl carbonate), and dimethyl carbonate (DMC) at a volume ratio of 30:35:35 so that the content of the lithium hexafluorophosphate was 1.0 mol/dm³ was used, and a polyolefin microporous membrane was used as a separator.

(Initial Charge-Discharge)

The obtained nonaqueous electrolyte energy storage device (uncharged and undischarged nonaqueous electrolyte energy storage device) before initial charge-discharge was subjected to initial charge-discharge at 25° C. in the following manner. Constant current constant voltage charge was performed at a charge current of 0.1 C and an end-of-charge voltage of 4.25 V (positive electrode achieved potential: 4.35 V vs. Li/Li⁺). An end-of-charge condition was set at a time point at which the current value decreased to 0.02 C. Thereafter, constant current discharge was performed at a discharge current of 0.1 C and an end-of-discharge voltage of 2.5 V. A nonaqueous electrolyte energy storage device of Example 1 was obtained by the above procedure.

### Examples 2 to 11, Comparative Examples 1 to 11, 13 to 16

Nonaqueous electrolyte energy storage devices of Examples 2 to 11 and Comparative Examples 1 to 11 and 13 to 16 were obtained similarly to Example 1 except that the amounts of nickel sulfate hexahydrate, cobalt sulfate heptahydrate and manganese sulfate pentahydrate used, and the amounts of the hydroxide precursor and lithium hydroxide monohydrate used were adjusted so that the molar ratio (Li/Me) of lithium to the transition metal and the molar ratio (Ni:Co:Mn) of Ni, Co and Mn in a desired lithium transition metal composite oxide were the values in Table 1, the firing temperature at the time of forming the positive active material particles and the presence or absence of aluminum (Al) in the positive active material particles were as described in Table 1, and the positive electrode achieved potential (positive electrode potential) during initial charge-discharge was the potential described in Table 1. The presence or absence of aluminum (Al) in the positive active material particles was adjusted depending on whether or not aluminum oxide Al₂O₃ was used in preparing the positive active material particles.

### Example 12 and Comparative Example 12

(Preparation of Carbonate Precursor)

17.7 g of nickel sulfate hexahydrate and 32.5 g of manganese sulfate pentahydrate were weighed, and all dissolved in 200 cm³ of ion-exchange water to prepare a 1.0 M aqueous sulfate solution of which the molar ratio of Ni:Mn was 33:67. Next, 750 cm³ of ion-exchange water was poured into a 2 dm³ reaction tank, and bubbled with CO₂ gas for 30 minutes to dissolve CO₂ in the ion-exchange water. The temperature of the reaction tank was set to 50° C. (±2° C.), and an arrangement was made so as to sufficiently generate a conviction flow in the reaction layer while the contents of the reaction tank was stirred at a rotation speed of 700 rpm using a paddle impeller equipped with a stirring motor. The whole amount of the aqueous sulfate solution was added dropwise at a rate of 2 cm³/min. Here, from the start of the dropwise addition until the completion thereof, an aqueous solution containing 1.0 mol/dm³ of sodium carbonate was appropriately added dropwise to perform control so that the pH in the reaction tank was always 7.9 (±0.05). After the end of the dropwise addition, stirring of the contents of the reaction tank was further continued for 5 hours. After the stirring was stopped, the mixture was allowed to stand at room temperature for 12 hours or more. Next, carbonate precursor particles generated in the reaction tank were separated using a suction filtration apparatus, and washed with ion-exchange water to remove sodium ions deposited on the particles. The carbonate precursor particles were dried at 80° C. for 20 hours under normal pressure in an air atmosphere using an electric furnace. Thereafter, for equalizing the particle sizes, the particles were ground for several minutes in a mortar made of agate. In this way, the carbonate precursor of which the molar ratio of Ni:Mn was 1:3 was obtained.

(Preparation of Lithium Transition Metal Composite Oxide Particles)

Lithium carbonate was added to the obtained carbonate precursor, and using a mortar made of agate, the mixture was adequately stirred to prepare a mixed powder of which the molar ratio (Li/Me) of Li:(Ni, Mn) was 1.3. The mixed powder was pelletized. The pellet was placed on an alumina boat, using a box-shaped electric furnace (model number: AMF 20), the temperature was raised from room temperature to a temperature of 890° C. over 10 hours under normal pressure in an air atmosphere, and firing was performed at 890° C. for 9 hours. After the firing, the heater was turned off, and the alumina boat was allowed to cool naturally while being left to stand in the furnace. As a result, although the temperature of the furnace decreased to about 200° C. after 5 hours, the subsequent temperature decrease rate was slightly low. After a lapse of an entire day and night, the temperature of the furnace was confirmed to be 60° C. or lower, and the pellets were then taken out, and ground for several minutes with an automatic mortar made of agate for equalizing the particle sizes.

In this way, lithium transition metal composite oxide particles (Ni:Mn=33:67, Li/Me=1.3) were prepared.

The lithium transition metal composite oxide particles were used as positive active material particles according to Comparative Example 12.

(Application of Aluminum to Lithium Transition Metal Composite Oxide Particles)

In a 0.3 dm³ Erlenmeyer flask, aluminum sulfate hydrate was dissolved in ion-exchange water to prepare an aqueous solution containing 0.5 mol/dm³ of aluminum sulfate, and 5.0 g of lithium transition metal composite oxide particles as the positive active material particles according to Comparative Example 12 was charged while stirring the mixture at 25° C. and a rotation speed of 400 rpm using a stirrer. After 30 seconds from the charging, stirring was stopped, filtration was performed by suction filtration, and drying was performed in air at normal pressure and 80° C. for 20 hours. Next, the solid matter was placed on a lid portion of a crucible made of alumina, using a box-shaped electric furnace (model number: AMF 20), the temperature was raised from room temperature to 400° C. at a rate of 5° C./min under normal pressure in an air atmosphere, and the solid matter was held at 400° C. for 4 hours, and then naturally cooled.

In this way, a lithium transition metal composite oxide (Ni:Mn=33:67, Li/Me=1.3) to which aluminum was added was prepared.

The lithium transition metal composite oxide was used as positive active material particles according to Example 12.

Nonaqueous electrolyte energy storage devices of Example 12 and Comparative Example 12 were obtained similarly to Example 1 except that the positive active material particles of Example 12 and Comparative Example 12 were used.

The peak differential pore volume of the positive active material particles obtained in each Example and Comparative Example was measured by the method described above. The measurement results are shown in Table 1. For each nonaqueous electrolyte energy storage device, separately, positive active material particles (lithium transition metal composite oxide) in a completely discharged state were taken out in a state after initial charge-discharge based on the above-described method, and X-ray diffraction measurement was performed to confirm the presence or absence of the diffraction peak in the range of 20° or more and 220 or less. The results are shown in Table 1.

(Charge-Discharge Cycle Test)

Each of the nonaqueous electrolyte energy storage devices of which the initial internal resistance was confirmed was subjected to a charge-discharge cycle test at 45° C. in the following manner. Constant current constant voltage charge was performed at a charge current of 1.0 C and an end-of-charge voltage of 4.25 V (positive electrode achieved potential: 4.35 V vs. Li/Li⁺). The end-of-charge condition was set at a time point at which the current value decreased to 0.05 C. Thereafter, constant current discharge was performed at a discharge current of 1.0 C and an end-of-discharge voltage of 2.5 V. A rest period of 10 minutes was provided after each of charge and discharge. This charge-discharge was performed 100 cycles.

(Rate of Increase in Internal Resistance)

With respect to each nonaqueous electrolyte energy storage device before the charge-discharge cycle test and after the charge-discharge cycle test, in each nonaqueous electrolyte energy storage device, the internal resistance (ACR) was measured using an AC impedance meter of 1 kHz in a state where 10 minutes or more had elapsed after the end of discharge. A rate (%) of increase in ACR after the charge-discharge cycle test relative to ACR before the charge-discharge cycle test was determined. The obtained rate of increase in internal resistance is shown in Table 1. With respect to the rate of increase in the internal resistance of the nonaqueous electrolyte energy storage device of each Comparative Example using the positive active material particles not containing aluminum, whether or not the rate of increase in the internal resistance of the nonaqueous electrolyte energy storage device of each Example or the like using the positive active material particles containing aluminum was decreased was evaluated. When the rate of increase in the internal resistance is decreased by containing aluminum, it can be evaluated that the increase in the internal resistance associated with the charge-discharge cycle is suppressed. The evaluation results are shown in Table 1 as “suppression effect”.

TABLE 1

| | | | | | Positive | | | | | |
|---|---|---|---|---|---|---|---|---|---|---|
| | | | | | electrode | | | | Rate of | |
| | | | | Firing | potential | | Peak | | increase in | |
| | | | | temper- | during initial | | differential | | internal | Suppres- |
| | | | Precursor | ature | charge discharge | Diffraction | pore volume | | resistance | sion |
| | Li/Me | Ni:Co:Mn | type | [° C.] | [V vs. Li/Li⁺] | peak | [mm³/(g/nm)] | Al | [%] | effect |
| Example 1 | 1.1 | 30:15:55 | Hydroxide | 900 | 4.35 | P (presence) | 0.038 | P | 2 | P |
| Comparative Example 1 | 1.1 | 30:15:55 | Hydroxide | 900 | 4.35 | P | 0.036 | A | 16 | — |
| Example 2 | 1.2 | 30:15:55 | Hydroxide | 900 | 4.35 | P | 0.043 | P | 3 | P |
| Comparative Example 2 | 1.2 | 30:15:55 | Hydroxide | 900 | 4.35 | P | 0.041 | A | 18 | — |
| Example 3 | 1.3 | 30:15:55 | Hydroxide | 900 | 4.35 | P | 0.037 | P | 4 | P |
| Comparative Example 3 | 1.3 | 30:15:55 | Hydroxide | 900 | 4.35 | P | 0.035 | A | 19 | — |
| Example 4 | 1.4 | 30:15:55 | Hydroxide | 900 | 4.35 | P | 0.030 | P | 5 | P |
| Comparative Example 4 | 1.4 | 30:15:55 | Hydroxide | 900 | 4.35 | P | 0.029 | A | 20 | — |
| Example 5 | 1.2 | 30:15:55 | Hydroxide | 850 | 4.35 | P | 0.180 | P | 3 | P |
| Comparative Example 5 | 1.2 | 30:15:55 | Hydroxide | 850 | 4.35 | P | 0.175 | A | 33 | — |
| Example 6 | 1.2 | 30:15:55 | Hydroxide | 800 | 4.35 | P | 0.300 | P | 3 | P |
| Comparative Example 6 | 1.2 | 30:15:55 | Hydroxide | 800 | 4.35 | P | 0.290 | A | 42 | — |
| Example 7 | 1.2 | 20:15:65 | Hydroxide | 900 | 4.35 | P | 0.055 | P | 2 | P |
| Comparative Example 7 | 1.2 | 20:15:65 | Hydroxide | 900 | 4.35 | P | 0.053 | A | 15 | — |
| Example 8 | 1.2 | 40:15:45 | Hydroxide | 900 | 4.35 | P | 0.036 | P | 3 | P |
| Comparative Example 8 | 1.2 | 40:15:45 | Hydroxide | 900 | 4.35 | P | 0.034 | A | 18 | — |
| Example 9 | 1.2 | 55:10:35 | Hydroxide | 900 | 4.35 | P | 0.035 | P | 3 | P |
| Comparative Example 9 | 1.2 | 55:10:35 | Hydroxide | 900 | 4.35 | P | 0.033 | A | 20 | — |
| Example 10 | 1.2 | 40:5:55 | Hydroxide | 900 | 4.35 | P | 0.045 | P | 3 | P |
| Comparative Example 10 | 1.2 | 40:5:55 | Hydroxide | 900 | 4.35 | P | 0.043 | A | 18 | — |
| Example 11 | 1.2 | 55:0:45 | Hydroxide | 900 | 4.35 | P | 0.050 | P | 3 | P |
| Comparative Example 11 | 1.2 | 55:0:45 | Hydroxide | 900 | 4.35 | P | 0.048 | A | 20 | — |
| Example 12 | 1.3 | 33:0:67 | Carbonate | 900 | 4.35 | P | 0.850 | P | 25 | P |
| Comparative Example 12 | 1.3 | 33:0:67 | Carbonate | 900 | 4.35 | P | 0.850 | A | 32 | — |
| Comparative Example 13 | 1.2 | 30:15:55 | Hydroxide | 900 | 4.70 | A (absence) | 0.043 | P | 35 | A |
| Comparative Example 14 | 1.2 | 30:15:55 | Hydroxide | 900 | 4.70 | A | 0.043 | A | 28 | — |
| Comparative Example 15 | 1.0 | 33:33:33 | Hydroxide | 900 | 4.35 | A | 0.032 | P | 22 | A |
| Comparative Example 16 | 1.0 | 33:33:33 | Hydroxide | 900 | 4.35 | A | 0.032 | A | 15 | — |

As can be seen from the comparison between Comparative Example 15 and Comparative Example 16, in the case of using the lithium transition metal composite oxide which was not the lithium-excess-type active material, when aluminum was contained in the positive active material particles, the rate of increase in the internal resistance after the charge-discharge cycle increased, and the effect of suppressing the increase in the internal resistance was not exhibited. In each of the nonaqueous electrolyte energy storage devices of Comparative Examples 15 and 16, the rate of increase in the internal resistance after the charge-discharge cycle exceeded 10%, and the rate of increase in the internal resistance was large.

As can be seen from the comparison between Comparative Example 13 and Comparative Example 14, even in the case of using the lithium transition metal composite oxide which was the lithium-excess-type active material having no diffraction peak in the range of 20° or more and 22° or less in the X-ray diffraction diagram, when aluminum was contained in the positive active material particles, the rate of increase in the internal resistance after the charge-discharge cycle increased, and the effect of suppressing the increase in the internal resistance was not exhibited. Also in each of the nonaqueous electrolyte energy storage devices of Comparative Examples 13 and 14, the rate of increase in the internal resistance after the charge-discharge cycle exceeded 10%, and the rate of increase in the internal resistance was large.

On the other hand, as can be seen from the comparison between Examples 1 to 12 and Comparative Examples 1 to 12, in the case of using the lithium transition metal composite oxide which was the lithium-excess-type active material having a diffraction peak in the range of 20° or more and 22° or less in the X-ray diffraction diagram, when aluminum was contained in the positive active material particles, the rate of increase in the internal resistance after the charge-discharge cycle decreased, and the effect of suppressing the increase in the internal resistance could be confirmed. Among Examples 1 to 12, in the nonaqueous electrolyte energy storage devices of Examples 1 to 11 prepared using the hydroxide precursor and using the positive active material particles having a peak differential pore volume of 0.5 mm³/(g nm) or less, the rate of increase in the internal resistance after the charge-discharge cycle was less than 10% in each Example, and the rate of increase in the internal resistance was very small.

### INDUSTRIAL APPLICABILITY

The present invention can be applied to a nonaqueous electrolyte energy storage device and the like used as a power source for electronic devices such as personal computers and communication terminals, automobiles, and industrial use and the like.

### DESCRIPTION OF REFERENCE SIGNS

1: nonaqueous electrolyte energy storage device
2: electrode assembly
3: case
4: positive electrode terminal
41: positive electrode lead
5: negative electrode terminal
51: negative electrode lead
20: energy storage unit
30: energy storage apparatus

1. A nonaqueous electrolyte energy storage device comprising a positive electrode having positive active material particles, wherein
the positive active material particles contain a lithium transition metal composite oxide having an α-NaFeO₂ structure,
the lithium transition metal composite oxide contains at least one of nickel and cobalt, and manganese,
a content of lithium with respect to a transition metal in the lithium transition metal composite oxide exceeds 1.0 in terms of a molar ratio,
a diffraction peak is present in a range of 20° or more and 22° or less in an X-ray diffraction diagram of the lithium transition metal composite oxide using a CuKα ray, and
the positive active material particles contain aluminum.

2. The nonaqueous electrolyte energy storage device according to claim 1, wherein a peak differential pore volume of the positive active material particles is 0.5 mm³/(g·nm) or less.

3. The nonaqueous electrolyte energy storage device according to claim 1, wherein a content of manganese with respect to the transition metal in the lithium transition metal composite oxide is 0.3 or more and 0.65 or less in terms of molar ratio.

4. The nonaqueous electrolyte energy storage device according to claim 1, wherein at least a part of the aluminum is interspersed in a particulate manner on a surface of the positive active material particles.

5. The nonaqueous electrolyte energy storage device according to claim 1, wherein a positive electrode potential at an end-of-charge voltage under normal usage is less than 4.5 V vs. Li/Li⁺.

6. A method for using the nonaqueous electrolyte energy storage device according to claim 1, comprising charging at a positive electrode potential in a range of less than 4.5 V vs. Li/Li⁺.

7. A method for manufacturing the nonaqueous electrolyte energy storage device according to claim 1, comprising performing initial charge-discharge at a positive electrode potential in a range of less than 4.5 V vs. Li/Li⁺.

8. The method for manufacturing the nonaqueous electrolyte energy storage device according to claim 7, further comprising obtaining the positive active material particles by firing a mixture containing a positive active material precursor, a lithium compound, and an aluminum compound.

9. An energy storage apparatus comprising:
two or more of nonaqueous electrolyte energy storage devices; and
one or more of the nonaqueous electrolyte energy storage devices according to claim 1.

10. A method for using the energy storage apparatus according to claim 9, comprising charging one or more of the nonaqueous electrolyte energy storage devices at a positive electrode potential in a range of less than 4.5 V vs. Li/Li⁺.

11. A method for manufacturing the energy storage apparatus according to claim 9, comprising performing initial charge-discharge of one or more of the nonaqueous electrolyte energy storage devices at a positive electrode potential in a range of less than 4.5 V vs. Li/Li⁺.
